(19) United States
(12) Patent Application Publication
(10) Pub. No.: US 2019/0384077 A1
(43) Pub. Date: Dec. 19, 2019

(54) METHOD OF PRODUCING SUBSTRATE FOR LIQUID CRYSTAL DISPLAY DEVICE AND PROCESSING DEVICE FOR SUBSTRATE FOR LIQUID CRYSTAL DISPLAY DEVICE

(71) Applicant: Sharp Kabushiki Kaisha, Sakai City (JP)

(72) Inventor: Kohshiroh TANIIKE, Sakai City (JP)

(21) Appl. No.: 16/435,718

(22) Filed: Jun. 10, 2019

Related U.S. Application Data
(60) Provisional application No. 62/684,253, filed on Jun. 13, 2018.

(51) Int. Cl. G02F 1/13; G02F 1/1337; B08B 3/02

(52) U.S. Cl. CPC G02F 1/13; G02F 2001/1316; B08B 3/022; G02F 1/133784

(57) ABSTRACT

A method of producing a substrate for a liquid crystal display device includes a cleaning step of, after performing a rubbing process for aligning liquid crystal molecules on a substrate, performing a cleaning process for the substrate. When the substrate is cleaned with an aqueous cleaner that flows along a conveying direction of the substrate, the supplying pressure of the aqueous cleaner is controlled to be smaller in a case where a rubbing process direction of the substrate and the conveying direction intersect than in a case where the rubbing process direction of the substrate and the conveying direction are along each other.

### CROSS REFERENCE TO RELATED APPLICATION

This application claims priority from U.S. Provisional Patent Application No. 62/684,253 filed on Jun. 13, 2018. The entire contents of the priority application are incorporated herein by reference.

### TECHNICAL FIELD

The technology described herein relates to a method of producing a substrate for a liquid crystal display device including a cleaning step of cleaning a substrate after a rubbing process for aligning liquid crystal molecules on the substrate, and a processing device for the substrate for the liquid crystal display device.

### BACKGROUND ART

Conventionally, in the production of a liquid crystal panel, which is a main component of a liquid crystal display device, a polymer film (alignment film) of polyimide or the like is formed on a surface of a liquid crystal glass substrate, and an alignment process for making the alignment film have anisotropy in a certain direction is performed by a rubbing process method, a polarized ultraviolet ray irradiation process method, or the like. In the rubbing process method, microscopic dust, shavings, or the like is generated because a surface of the alignment film is rubbed in the certain direction with a rubbing roller that is rotated. Therefore, in order to remove the foreign substance adhering to the surface of the substrate (alignment process surface) after the rubbing process, the substrate surface is cleaned with pure water. An example of such a system is disclosed in Japanese Patent Application Publication No. H4-221925.

A processing device for the substrate for the liquid crystal display device according to the above Patent Literature includes a rotation type brushing roller that brushes the substrate for the liquid crystal display device for cleaning. By making the rotating direction of the brushing roller and the rotation direction of a rubbing roller opposite, the foreign substance caught by a foundation structure on the alignment process surface, which cannot be easily removed by the ultrasonic cleaning, can be removed and thus, the cleaning effect can be increased.

However, due to the contact with the brushing roller, an unnecessary damage is caused in the alignment film and the alignment disorder occurs; thus, the alignment process effect may decrease. Moreover, due to the flow of an aqueous cleaner that is used with the brushing roller, the alignment disorder also occurs and the alignment process effect may decrease.

### SUMMARY

The technology described herein has been made in view of the above circumstance, and an object is to achieve a high cleaning power without decreasing the alignment process effect.

One embodiment of the technology described herein is a method of producing a substrate for a liquid crystal display device, the method including a cleaning step of, after performing a rubbing process for aligning liquid crystal molecules on a substrate, performing a cleaning process for the substrate. When the substrate is cleaned with an aqueous cleaner that flows along a conveying direction of the substrate in the cleaning step, the supplying pressure of the cleaner is controlled to be smaller in a case where a rubbing process direction of the substrate and the conveying direction intersect than in a case where the rubbing process direction of the substrate and the conveying direction are along each other.

If the rubbing process direction of the substrate intersects with the conveying direction of the substrate, that is, the flowing direction of the cleaner, the foreign substance caught by a foundation structure on the alignment process surface is removed easily. Thus, the cleaning power can be increased without the use of a brushing roller. On the other hand, in this case, the alignment disorder due to the flow of the cleaner occurs more easily and the alignment process effect by the rubbing process decreases more easily than in the case where the rubbing process direction of the substrate is along the conveying direction, that is, the flowing direction of the cleaner. Therefore, by controlling the supplying pressure of the cleaner to be smaller, the cleaning power can be increased and moreover, the decrease in alignment process effect can be suppressed.

An embodiment of the technology described herein is a processing device for the substrate for the liquid crystal display device for, after performing a rubbing process of aligning liquid crystal molecules on a substrate, performing a cleaning process for the substrate. The processing device includes a conveying device that conveys the substrate in a conveying direction, and a cleaning tank where the substrate is cleaned with an aqueous cleaner that flows along the conveying direction of the substrate. When the substrate is cleaned with the aqueous cleaner that flows along the conveying direction in the cleaning tank, the supplying pressure of the cleaner is controlled to be smaller in a case where a rubbing process direction of the substrate and the conveying direction intersect than in a case where the rubbing process direction of the substrate and the conveying direction are along each other.

According to the technology described herein, the high cleaning power can be achieved without decreasing the alignment process effect.

### BRIEF DESCRIPTION OF THE DRAWINGS

FIG. 1 is a side view of a cleaning step according to a first embodiment of the technology described herein.

FIG. 2 is a perspective view illustrating a cleaning process by a curtain shower and a nozzle shower.

FIG. 3 is a perspective view showing a rubbing process direction along a long-side direction of a substrate.

FIG. 4 is a perspective view showing a rubbing process direction along a short-side direction of a substrate.

FIG. 5 is a perspective view illustrating the cleaning process by the nozzle shower.

FIG. 6 is a top view showing a range where the rubbing process direction of the substrate is along the long side.

FIG. 7 is a top view showing a range where the rubbing process direction of the substrate is along the short side.

FIG. 8 is Table 1 showing experiment results of Comparative experiment 1.

### DETAILED DESCRIPTION

### First Embodiment

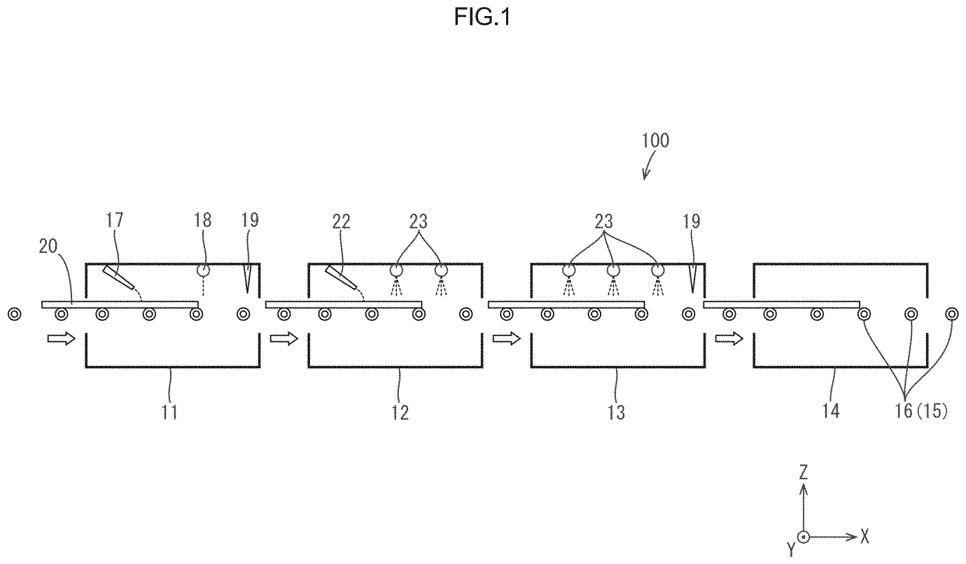

A first embodiment of the technology described herein is described with reference to FIG. 1 to FIG. 6. In the present embodiment, a processing device 100 for a substrate for a liquid crystal display device for performing a cleaning process for a substrate is described. In the description below, in FIG. 1, an X-axis direction is a conveying direction of a substrate 20, a Y-axis direction that is orthogonal to the paper surface is a left-right direction, and a Z-axis direction is an up-down direction. In each drawing, the left side is an upstream side of the conveying direction and the right side is a downstream side of the conveying direction.

The processing device 100 for the substrate for the liquid crystal display device is used in a cleaning step of, after performing a rubbing process for aligning the liquid crystal molecules on the substrate, performing a cleaning process for the substrate in the method of producing substrate for the liquid crystal display device. Specifically, from the substrate 20 in a state where an alignment film applied on a surface of the substrate is subjected to an alignment process (rubbing process) by a rubbing method and a foreign substance such as microscopic dust or shavings adheres to the surface, the foreign substance is cleaned.

The processing device 100 for the substrate for the liquid crystal display device includes a plurality of process tanks as illustrated in FIG. 1. In the processing device 100 for the substrate for the liquid crystal display device, the substrate 20 with a plate shape is conveyed to the upstream side in the conveying direction in a horizontal state with an alignment process surface 20A (rubbed surface) facing upward, and then conveyed from the upstream side to the downstream side in the conveying direction by a conveying device 15 to be described below in a posture with a long-side direction thereof along the X-axis direction and a short-side direction thereof along the Y-axis direction.

The processing device 100 for the substrate for the liquid crystal display device specifically includes four process tanks as illustrated in FIG. 1. These tanks are a film processing tank 11, a substituting tank 12, a cleaning tank 13, and a drying tank 14 in the order from the upstream side (from the left side). The processing device 100 for the substrate for the liquid crystal display device includes the conveying device 15. This conveying device 15 includes a plurality of conveyance rollers 16 that conveys the substrate in the conveying direction (X-axis direction) with a driving source. While a plate surface (lower surface) of the substrate 20 that is opposite to the alignment process surface 20A is intermittently supported by the conveyance rollers 16, the substrate 20 is conveyed to the respective tanks in order by the conveying device 15 along the conveying direction and processed therein. In the present embodiment, the substrate 20 has the G4.5 size or G6 size and is conveyed at a speed of 2000 to 3000 mm/min.

The film processing tank 11 is a tank for forming a thin film of isopropyl alcohol (IPA 21) (one example of pretreatment material) on the surface of the substrate 20 after the rubbing process and before the water cleaning, that is, the alignment process surface 20A. The IPA 21 is formed as the pretreatment in order for pure water 24 to entirely cover the substrate surface in the substituting tank 12 to be described below. On the upstream side in the conveying direction in the film processing tank 11, a curtain shower 17 (one example of first supplying device) is provided, and on the downstream side, a pipe shower 18 (one example of second supplying device) is provided. With these two showers, the IPA 21 is supplied to the alignment process surface 20A and the IPA 21 flows along the conveying direction of the substrate 20.

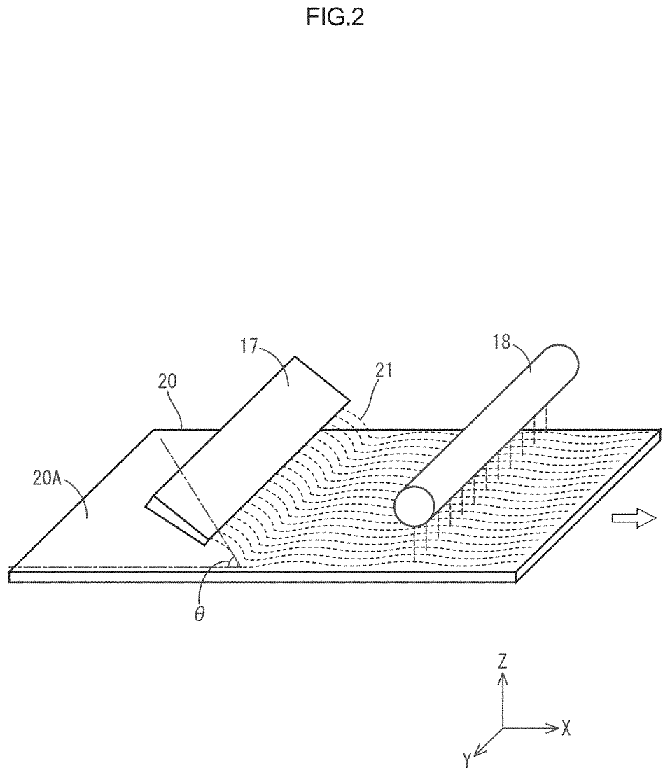

The curtain shower 17 is connected to a pipe extended from an IPA storage tank, and is provided along the alignment process surface 20A of the substrate 20 (XY plane) and also extended long and thin in a direction (Y direction) that is orthogonal to the conveying direction as illustrated in FIG. 2. At a lower end of the curtain shower 17, a long and thin slit is formed. This slit is used to discharge the IPA 21 in a curtain shape. This slit is set such that the IPA 21 is supplied in what is called a liquid curtain shape to the downstream side (to the right side in FIG. 1) in the conveying direction at a predetermined inclination angle θ to the alignment process surface 20A (XY plane) of the substrate 20. With the IPA 21 discharged obliquely from the curtain shower 17, the alignment process surface 20A of the substrate is covered with the IPA thin film in the substantially uniform state with almost no unevenness.

The pipe shower 18 is made of metal, and is connected to a pipe extended from the IPA storage tank. The pipe shower 18 has a cylindrical shape that is provided along the alignment process surface 20A (XY plane) of the substrate 20 and extended long and thin in the direction (Y direction) that is orthogonal to the conveying direction. A surface (lower surface) of the pipe shower 18 that faces the substrate 20 includes a plurality of discharging holes arranged in a line at equal intervals, and the IPA 21 is discharged vertically to the substrate 20. In the present embodiment, discharging holes 18A of the pipe shower 18 are arranged in a line at equal intervals, and a plurality of discharging holes 18A have the same hole diameter. Specifically, the hole diameter of each discharging hole 18A is 0.5 mmϕ to 1.0 mmϕ, and the distance between the adjacent discharging holes 18A is 10 mm to 15 mm. The total discharging flow rate from the respective discharging holes is 5 to 20 liters/min. With the IPA 21 discharged from the pipe shower 18, the IPA thin film is formed in the width direction on the alignment process surface 20A of the substrate 20 just before the substrate 20 is conveyed out of the film processing tank 11. By supplying the IPA 21 from the pipe shower 18 again, the partial drying of the IPA 21 can be prevented.

On the substrate 20, excess IPA is removed by an air knife 19 provided near an exit of the film processing tank 11, and with the upper surface covered entirely with the thin film of the IPA 21, the substrate 20 is conveyed from the film processing tank 11 to the substituting tank 12 (FIG. 1).

On the upstream side in the substituting tank 12, a curtain shower 22 in a mode similar to that in the film processing tank 11 is provided. This curtain shower 22 discharges the pure water 24 for substitution onto the substrate 20. On the downstream side of the curtain shower 22, similarly, nozzle showers 23 (one example of cleaner supplying device) made of resin including a plurality of nozzles to radially jet the pure water 24 for substitution onto the substrate 20 are provided. The supplied pure water 24 is jetted to the surface of the substrate 20 and flows along the conveying direction of the substrate 20.

The nozzle shower 23 is provided along the alignment process surface 20A of the substrate 20 and extended linearly in the direction (Y-axis direction) that is orthogonal to the conveying direction. The nozzle showers 23 are provided in two to four lines (in the present embodiment, two lines) in a manner that the lines are orthogonal to the conveying direction. The IPA 21 is substituted with the pure water 24 that is supplied to the alignment process surface 20A, and the substrate surface is covered with the pure water 24 entirely.

The substrate 20 whose surface is substituted with the pure water in the substituting tank 12 is conveyed into the cleaning tank 13 by the conveying device 15. In the cleaning tank 13, the nozzle showers 23 in a mode similar to those in the substituting tank 12 are provided in a plurality of lines (in the present embodiment, three lines) in a manner that the lines are orthogonal to the conveying direction. With the pure water 24 jetted from the nozzle showers 23, the substrate 20 is cleaned with high pressure and the foreign substance on the alignment process surface 20A is removed.

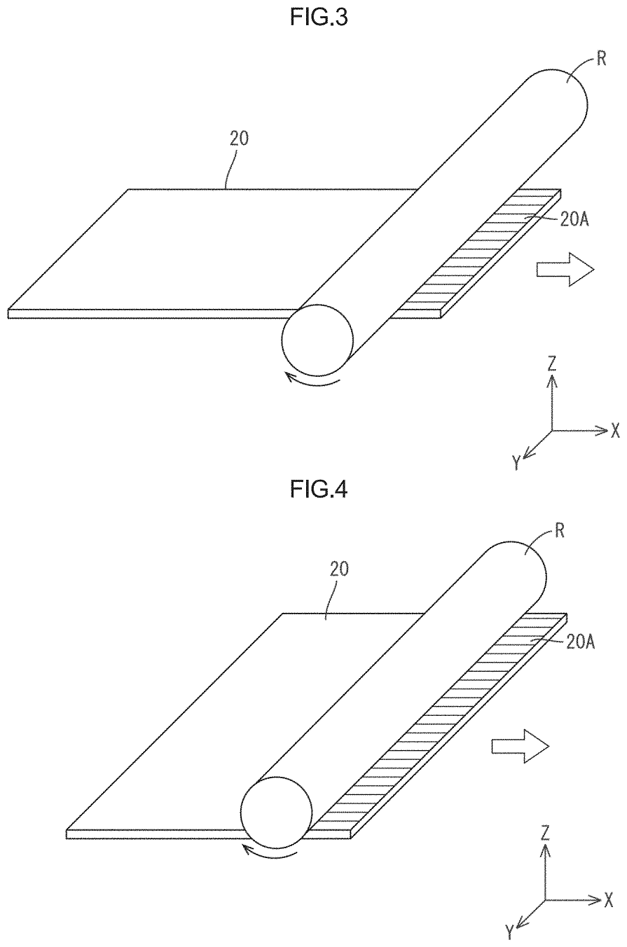

Next, the removal of the foreign substance from the alignment process surface 20A by the nozzle showers 23 is described. First, the state of the alignment process surface 20A is described in detail. The alignment process surface 20A of the substrate 20 has been subjected to the rubbing process in which the surface of the alignment film is rubbed in a certain direction by a rubbing roller R as illustrated in FIG. and FIG. 4. FIG. 3 and FIG. 4 illustrate the rubbing process performed along the long-side direction and the short-side direction of the substrate 20. On the surface having passed the rubbing roller R (alignment process surface 20A), microscopic dust or shavings (cut pile of a rubbing cloth or shavings of the alignment film) are generated by the rubbing process. On the alignment process surface 20A, those foreign substances are caught by the foundation structure of the substrate (photo spacer formed on a color filter substrate or an electrode formed on an array substrate).

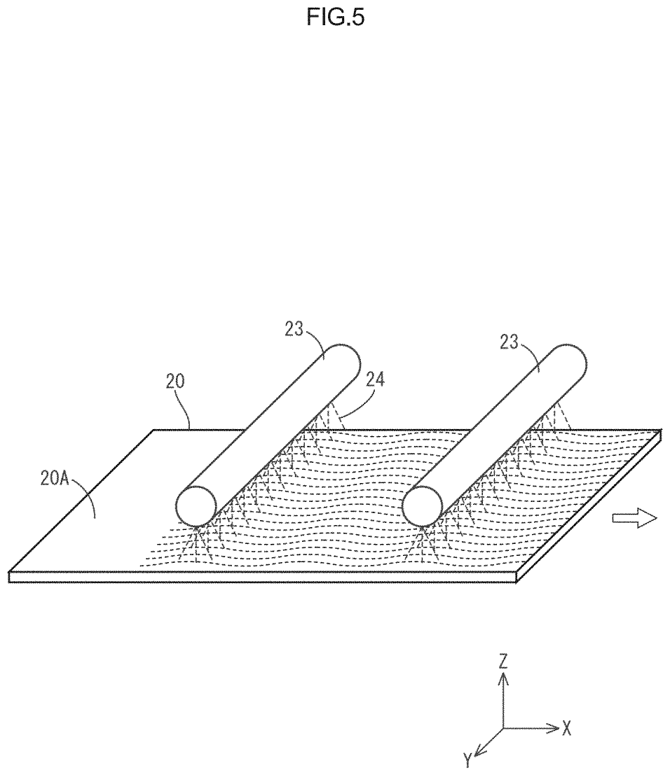

As illustrated in FIG. 5, a plurality of (in the present embodiment, twelve) high-pressure discharging holes is provided to the surface (lower surface) of the nozzle shower 23 that faces the substrate 20 in a line at equal intervals, and the pure water 24 is discharged radially with high pressure to the substrate 20. The plurality of high-pressure discharging holes have the same hole diameter, and specifically, the hole diameter of each high-pressure discharging hole is 0.3 mm, and the distance between the adjacent high-pressure discharging holes is 60 mm. The discharging pressure ranges from 4 MPa to 15 MPa, and the total quantity of liquid discharged from the respective high-pressure discharging holes is 8 to 17 liters/min. In the present embodiment, the discharging pressure of the pure water 24 jetted from the nozzle shower 23 is controlled in accordance with the rubbing process direction of the substrate 20. Specifically, in a case where the rubbing process direction of the substrate 20 intersects with the conveying direction, the discharging pressure is controlled to be smaller than in the case where the rubbing process direction is along the conveying direction.

In the case where the rubbing process direction is along the long-side direction (FIG. 3), the rubbing process direction of the substrate 20 in FIG. 5 is the X-axis direction, is along the conveying direction and the flowing direction of the pure water 24 that flows along the conveying direction, and intersects with the Y-axis direction where the nozzle shower 23 is extended. In the case where the rubbing process direction is along the short-side direction (FIG. 4), the substrate 20 is rotated by 90° such that the long-side direction coincides with the conveying direction and then, the substrate 20 is conveyed into the processing device 100 for the substrate for the liquid crystal display device. Therefore, the rubbing process direction of the substrate 20 in FIG. 5 becomes the Y-axis direction, intersects with the conveying direction and the flowing direction of the pure water 24 that flows along the conveying direction, and is along the Y-axis direction where the nozzle shower 23 is extended.

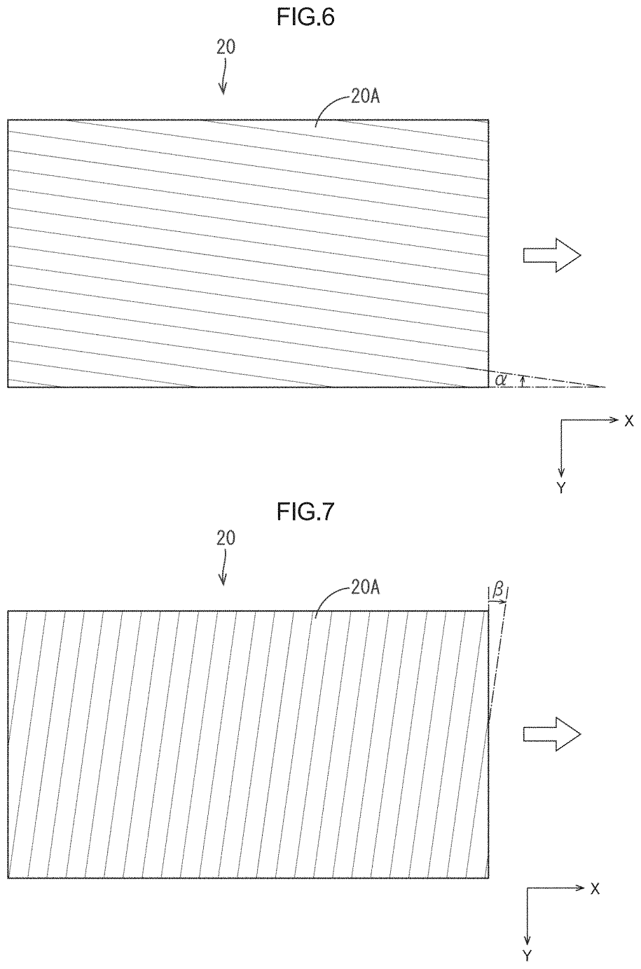

Note that as illustrated in the top view in FIG. 6 and FIG. 7, the actual rubbing process direction may be along the long side with an inclination angle α from the long side (FIG. 6) or may be along the short side with an inclination angle θ from the short side (FIG. 7). Therefore, in the present specification, the rubbing direction and the long side of the substrate (conveying direction) are defined as being along each other when the inclination angle α ranges from 0° to +30° inclusive (in FIG. 6, 30° clockwise) and from 0° to −30° inclusive (in FIG. 6, 30° counterclockwise), and the rubbing direction and the long side of the substrate (conveying direction) are defined as intersecting with each other when the inclination angle θ ranges from 0° to +30° inclusive (in FIG. 7, 30° clockwise) and from 0° to −30° inclusive (in FIG. 7, 30° counterclockwise).

Near the exit of the cleaning tank 13, the air knife 19 is provided. The substrate 20 from which the liquid has been removed by the air knife 19 is conveyed to the drying tank 14 by the conveying device 15. In the drying tank 14, the moisture remaining on the substrate 20 that the air knife 19 has failed to remove is completely removed. Then, after drying at high temperature, the substrate 20 is conveyed out of the processing device 100 for the substrate for the liquid crystal display device.

The present embodiment has the structure as described above, and next, the operation and effect of the processing device 100 for the substrate for the liquid crystal display device are described. In the processing device 100 for the substrate for the liquid crystal display device with the above structure, if the rubbing process direction of the substrate 20 is the Y-axis direction and intersects with the conveying direction, that is, the X-axis direction corresponding to the flowing direction of the pure water 24, the foreign substance that is caught by the foundation structure on the alignment film surface can be easily removed by the water flow that intersects with the rubbing process direction. Thus, the cleaning power can be increased without the use of the brushing roller.

On the other hand, in this case, the alignment disorder may occur in the alignment process surface 20A due to the flow of the pure water 24. This is because a damage that is too small to see with eyes is formed crossing the rubbing process direction on the alignment process surface 20A due to the water flow. Therefore, in the case where the rubbing process direction of the substrate 20 and the conveying direction intersect, the supplying pressure of the pure water 24 (discharging pressure of nozzle shower 23) is controlled to be lower than in the case where these directions are along each other. In this case, the cleaning power can be increased and at the same time, the decrease in aligning process effect can be suppressed.

<Comparative Experiment 1>

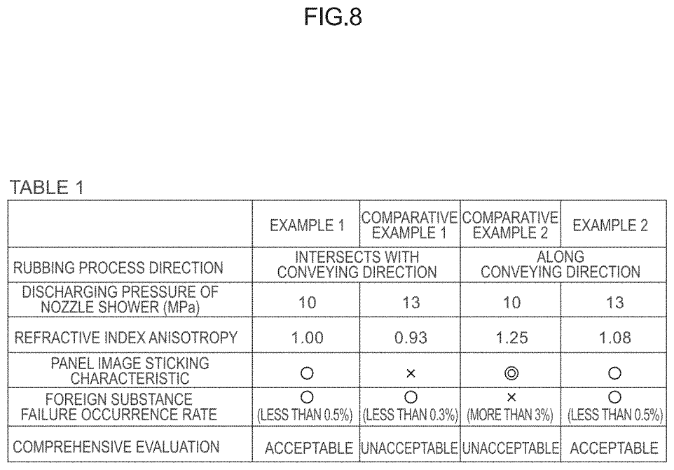

In order to demonstrate the operation and effect as described above, Comparative experiment 1 was performed. In Comparative experiment 1, a substrate with a planar size of 680 mm×880 mm was used and the discharging pressure of the nozzle shower was controlled to 10 MPa and 13 MPa in the case where the rubbing process direction of the substrate and the conveying direction intersect in Example 1 and Comparative example 1, respectively and the discharging pressure of the nozzle shower was controlled to 10 MPa and 13 MPa in the case where the rubbing process direction of the substrate and the conveying direction are along each other in Comparative example 2 and Example 2, respectively. In these examples and comparative examples, the refractive index anisotropy of the substrate 20 was measured and the panel image sticking characteristic and the foreign substance failure occurrence rate were evaluated. The experiment results are shown in Table 1 (FIG. 8).

<Measurement of Refractive Index Anisotropy>

Light is delivered from above the alignment process surface side of the substrate with the alignment film, and the retardation (Δnd) of the transmission light at measurement points (12 points that are separated) on the substrate is measured, and by dividing the obtained value by the film thickness (d) of each alignment film, the refractive index anisotropy (Δn) was calculated. In addition, the average and the standard deviation at each measurement point were calculated. The retardation (Δnd) was measured using “Axo Scan FAA-3 series” manufactured by Axo Metrics. The film thickness was measured through contact level difference measurement using “Full-automatic high-precision fine shape measuring instrument ET5000” manufactured by Kosaka Laboratory Ltd. In Table 1, the values are standardized using the calculation value in Example 1 as a reference value 1, and as the value is larger, the anisotropy of the alignment film is superior.

<Panel Image Sticking Characteristic>

As the simplified evaluation method, the voltage is applied for two hours to the panel with screen display of black and white checkered pattern, and then, the residual image luminance level (black and white difference) immediately after, or with a predetermined relief time after the entire panel surface is changed to an intermediate gradation solid display is compared. The level at which the visual recognition with naked eyes is impossible is expressed by a double circular mark, the level at which the visual recognition through an ND (neutral density) filter with a transmission of 10% to 8% is impossible is expressed by a single circular mark, and the level at which the visual recognition through an ND filter with a transmission of 3% is still possible is expressed by a crossed mark.

<Foreign Substance Failure Occurrence Rate>

The occurrence rate of the bright spot defect due to the foreign substance that is visually recognized in a 10-inch liquid crystal panel is compared. An occurrence rate of less than 0.5% is expressed by a circular mark and an occurrence rate of more than 3% is expressed by a crossed mark.

The experiment results of Comparative experiment 1 are described. As for the substrate according to Comparative example 1, the foreign substance failure occurrence rate is as low as less than 0.3% as shown in Table 1; however, the substrate according to Comparative example 1 has the low refractive index anisotropy and is inferior in the panel image sticking characteristic. Therefore, the substrate according to Comparative example 1 was unacceptable in the comprehensive evaluation. It is considered that this is because, although the high cleaning power is achieved with the water flow crossing the rubbing process direction, the alignment disorder occurs and the alignment process effect applied by the rubbing process decreases. On the other hand, as for the substrate according to Example 1, the foreign substance failure occurrence rate is as low as less than 0.5% and the refractive index anisotropy and the panel image sticking characteristic are both excellent. Therefore, the substrate according to Example 1 was acceptable in the comprehensive evaluation. It is considered that this is because the discharging pressure of the nozzle shower is controlled to be lower than that in Comparative example 1 and therefore the decrease in alignment process effect is suppressed while the high cleaning power is maintained.

As for the substrate according to Comparative example 2, the refractive index anisotropy is high and the panel image sticking characteristic is excellent as shown in Table 1. However, the foreign substance failure occurrence rate is as high as more than 3%; therefore, the substrate according to Comparative example 2 was unacceptable in the comprehensive evaluation. It is considered that the reason is as follows: although the alignment disorder does not occur and the alignment process effect does not decrease by the water flow along the rubbing process direction, the cleaning power is insufficient and the foreign substance caught by the foundation structure remains on the alignment process surface. On the other hand, as for the substrate according to Example 2, the foreign substance failure occurrence rate is as low as less than 0.5% and the high cleaning power is achieved, and the refractive index anisotropy and the panel image sticking characteristic are both excellent. Therefore, the substrate according to Example 2 was acceptable in the comprehensive evaluation. It is considered that this is because the discharging pressure of the nozzle shower is controlled to be higher than that in Comparative example 2; therefore, the high cleaning power can be achieved.

Comparing Example 2 and Example 1 indicates that if the rubbing process direction of the substrate 20 and the conveying direction intersect (Example 1), the cleaning power can be increased and the decrease in the alignment process effect can be suppressed by controlling the discharging pressure of the nozzle shower 23 to be smaller than that in the case where these directions are along each other (Example 2). In all the examples and comparative examples, it has been confirmed that the refractive index anisotropy (anisotropy of alignment film) and the panel image sticking characteristic are correlated with each other, and as the anisotropy is higher, the panel image sticking characteristic is enhanced.

Note that using the nozzle shower 23 as the means of supplying the pure water 24 can increase the cleaning power because the alignment process surface 20A can be cleaned with high pressure. However, since the water flow becomes more intense, the alignment disorder due to the flow of the pure water 24 occurs more easily. Thus, the operation of controlling the discharging pressure of the nozzle shower 23 becomes more effective.

In addition, the rubbing process direction of the substrate 20 is set along the short-side direction or the long-side direction and if the rubbing process direction is along the short-side direction (FIG. 4), the substrate 20 is rotated by 90° such that the long-side direction coincides with the conveying direction and the substrate 20 is conveyed into the processing device 100 for the substrate for the liquid crystal display device. Thus, even if the rubbing process direction of the substrate 20 is different, controlling the supplying pressure of the cleaner as above facilitates the cleaning by using the same production line (using the same processing device 100 for the substrate for the liquid crystal display device).

### OTHER EMBODIMENTS

The technology described herein is not limited to the embodiments described above with reference to the drawings, and for example, the following embodiments are also included in the technical range of the technology described herein.

(1) In the above embodiments, the IPA is used as the pretreatment material and the pure water is used as the aqueous cleaner; however, the pretreatment material and the aqueous cleaner are not limited thereto and may be other materials.

(2) In the above embodiments, the curtain shower is used as the first supplying device and the pipe shower is used as the second supplying device; however, the technology described herein is not limited thereto. A supplying device in another mode, such as a nozzle shower made of metal with a resistance against IPA, can also be used. The number of showers may be changed as appropriate.

(3) In the above embodiments, the pipe shower and the nozzle shower have their discharging holes (high-pressure discharging holes) with the same diameter arranged in a line at equal intervals; however, the discharging holes (high-pressure discharging holes) may be different in intervals or hole diameter partially or entirely, and the number of lines may also be changed as appropriate.

(4) The curtain shower (first supplying device), the pipe shower (second supplying device), the nozzle shower (cleaner supplying device) may not be disposed in the direction orthogonal to the conveying direction. For example, the showers may be disposed in a V-like shape such that the center in the width direction is disposed on the downstream side of the conveying direction and both ends are disposed on the upstream side.

(5) In the above embodiments, the substrate processing device includes one cleaning tank; however, the number of cleaning tanks is not limited to one. The cleaning method in each cleaning tank is not limited to the nozzle shower and may be selected freely in accordance with the effect of removing the foreign substance, for example an ultrasonic shower, a bubble jet, a cavitation jet, a high-pressure spray shower, or a binary fluid.

(6) In the above embodiments, the four processing tanks are separate tanks; however, if a plurality of cleaning tanks are used, the cleaning tanks may be formed by sectioning one tank.

(7) In the above embodiments, the conveying direction coincides with the long-side direction of the substrate; however, the conveying direction may be the short-side direction. In the above embodiments, the conveying speed of the substrate is 2000 mm/min to 3000 mm/min; however, the technology described herein is also applicable to other speed.

(8) In the above embodiments, the substrate 20 has a G4.5 or G6 size; however, the technology described herein is also applicable to substrates with other size.

1. A method of producing a substrate for a liquid crystal display device, the method comprising a cleaning step of, after performing a rubbing process for aligning liquid crystal molecules on a substrate, performing a cleaning process for the substrate, wherein when the substrate is cleaned with an aqueous cleaner that flows along a conveying direction of the substrate in the cleaning step, a supplying pressure of the aqueous cleaner is controlled to be smaller in a case where a rubbing process direction of the substrate and the conveying direction intersect than in a case where the rubbing process direction of the substrate and the conveying direction are along each other.

2. The method of producing the substrate for the liquid crystal display device according to claim 1, wherein the aqueous cleaner is supplied in a manner that the aqueous cleaner is jetted with high pressure.

3. The method of producing the substrate for the liquid crystal display device according to claim 1, wherein:
the substrate has a plate shape;
the conveying direction is along a long-side direction of the substrate;
if the rubbing process direction of the substrate and the conveying direction intersect, the rubbing process direction is along a short-side direction of the substrate; and
if the rubbing process direction of the substrate and the conveying direction are along each other, the rubbing process direction is along the long-side direction of the substrate.

4. A processing device for a substrate for a liquid crystal display device for cleaning the substrate after a rubbing process of aligning liquid crystal molecules on a substrate, the processing device comprising:
a conveying device configured to convey the substrate in a conveying direction; and
a cleaning tank for cleaning the substrate with an aqueous cleaner therein, the aqueous cleaner flowing along the conveying direction of the substrate, wherein
when the substrate is cleaned with the aqueous cleaner that flows along the conveying direction in the cleaning tank, a supplying pressure of the aqueous cleaner is controlled to be smaller in a case where a rubbing process direction of the substrate and the conveying direction intersect than in a case where the rubbing process direction of the substrate and the conveying direction are along each other.

5. The processing device for the substrate for the liquid crystal display device according to claim 4, wherein the cleaning tank includes a nozzle shower that supplies the aqueous cleaner in a manner of jetting the aqueous cleaner with high pressure.

6. The processing device for the substrate for the liquid crystal display device according to claim 4, wherein:
the substrate has a plate shape;
the conveying direction is along a long-side direction of the substrate;
if the rubbing process direction of the substrate and the conveying direction intersect, the rubbing process direction is along a short-side direction of the substrate; and
if the rubbing process direction of the substrate and the conveying direction are along each other, the rubbing process direction is along the long-side direction of the substrate.
